(19) United States
(12) Patent Application Publication
(10) Pub. No.: US 2012/0121889 A1
(43) Pub. Date: May 17, 2012

(54) COMPOSITE FILM AND MANUFACTURING METHOD THEREOF

(76) Inventors: Ting-Chu Hsu, Tainan Hsien (TW); Shun-Cheng Wang, Tainan Hsien (TW); Wan-Sen Lu, Tainan Hsien (TW); Heng-Yueh Su, Tainan Hsien (TW); Ya-Chen Lin, Tainan Hsien (TW)

(21) Appl. No.: 12/948,711

(22) Filed: Nov. 17, 2010

(51) Int. Cl. B32B 5/16; B05D 1/36; B32B 7/12

(52) U.S. Cl. 428/323; 428/352; 427/402

(57) ABSTRACT

The composite film contains a carrier layer, a release layer dispersed with a number of particles, a hardening layer, an ink layer, and an adhesive layer, stacked in this sequential order. The diameters of at least a portion of the particles are larger than the thickness of the release layer. A manufacturing method of the composite file is provided as well.

### (a) TECHNICAL FIELD OF THE INVENTION

The present invention generally relates to composite films for insert molding processes, and more particular to a composite film capable of achieving various anti-fingerprint capabilities and degrees of gloss.

### (b) DESCRIPTION OF THE PRIOR ART

Insert molding is an injection molding technique that transfers ink or pattern having a hardening layer onto a work piece. The hardening layer usually would form a protective and smooth coating and it would be difficult to produce a desired texture on the work piece.

One of the insert molding processes, in-mold decoration (LIVID), is commonly applied to consumer electronic appliances such s mobile phones, notebook computers, etc. The work piece is usually highly glossy due to the smooth hardening layer and as such fingerprints are very obvious and annoying. A way to overcome this problem is to spray-coat a layer of wax. Yet the resolution is not environmental friendly and the product yield is often adversely affected by the spray coating process. On the other hand, sometimes it is also required to achieve work pieces with little or no gloss. The conventional IMD processes are not satisfactory in this respect.

The achieve anti-fingerprint or low gloss, a resolution is to add micro particles in the hardening layer to form roughened surface and to reduce gloss by the micro particles' scattering light. The micro particles usually have a diameter larger than the thickness of the hardening layer so as to achieve the roughened surface. Yet, it is difficult to achieve uniform distribution of these larger particles and the light scattering effect is affected.

Yet another resolution capable of anti-fingerprint and low gloss is to add particles in a release layer of the insert molding process. However, the release layer usually contains silicone and is not quite compatible with the particles, leading to the separation of organic and inorganic phases and non-uniform distribution of the particles.

It is also possible to add particles into the film for forming a carrier layer of the insert molding process. Then, when the carrier layer is covered by the release layer subsequently, surface roughness is achieved on the release layer. However, the production of the film is very expensive and the resolution is financially viable.

### SUMMARY OF THE INVENTION

Therefore, a novel composite film and a related manufacturing of the composite film are provided herein so that the composite film could be applied in an insert molding process to achieve a required degree of gloss and anti-fingerprint capability for the work piece and final product. Another objective of the present invention is to resolve the non-uniform particle distribution in the release layer and high production cost problems of the prior art.

To achieve the forgoing objectives, a composite film is provided which contains a carrier layer, a release layer dispersed with a number of particles, a hardening layer, an ink layer, and an adhesive layer, stacked in this sequential order. The diameters of at least a portion of the particles are larger than the thickness of the release layer.

The particles could be wax, SiO₂, TiO₂, or polyurethane (PU) particles, or a combination of these particles. The diameters of these particles are between 1 to 5 μm. Depending on the roughness or degree of gloss required, the amount or percentage of the particles could be adjusted accordingly. Preferably, relative to the release layer, the weight percentage of the particles is between 2 to 20% wt.

According to the present invention, the surface of the composite film has a degree of gloss at 60° angle between 2 to 99.

The manufacturing method is as follows. First, a carrier layer is provided. Then, a release layer is formed on the carrier layer and a number of particles are dispersed in the release layer. Subsequently, a hardening layer is formed on the release layer, and an ink layer on the hardening layer, and an adhesive layer on the ink layer. The diameters of at least a portion of the particles have to be larger than the thickness of the release layer.

The particles could be wax, SiO₂, TiO₂, or polyurethane (PU) particles, or a combination of these particles. The diameters of the particles are between 1 to 5 μm. Also, depending on the roughness or degree of gloss required, the amount or percentage of the particles could be adjusted accordingly. Preferably, relative to the release layer, the weight percentage of the particles is between 2 to 20% wt.

According to the present invention, the surface of the composite film thus formed has a degree of gloss at 60° angle between 2 to 99.

Optionally, when the particles are dispersed in the release layer, an additional polymer- or ion-type interface agent could be added as dispersion agent, so that the particles are uniformly distributed. Preferably, the percentage of the polymer- or ion-type interface agent relative to the release layer 101 is between 0.1 to 2%.

After the composite film is formed as described above, an injection molding step is conducted to apply the composite film on a work piece.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the structure of a composite film according to an embodiment of the present invention

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

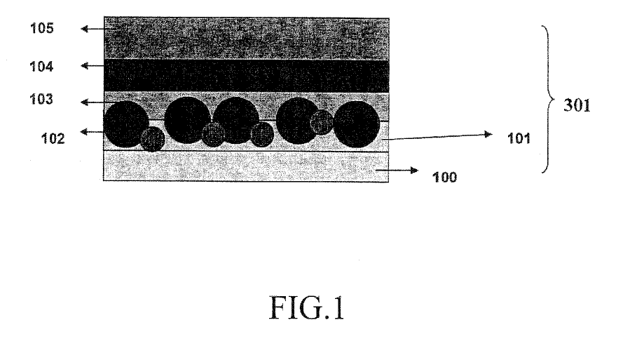

As shown in FIG. 1, a composite film 301 according to an embodiment of the present invention contains a carrier layer 100, a release layer 101 dispersed with a number of particles 102, a hardening layer 103, an ink layer 104, and an adhesive layer 105, stacked in this sequential order. The diameters of at least a portion of the particles 102 are larger than the thickness of the release layer 101. The particles 102 could be wax, SiO₂, TiO₂, or polyurethane (PU) particles, or a combination of these particles.

A manufacturing method of the composite film 301 is described as follows. First, a carrier layer 100 is provided. Then, a release layer 101 is formed on the carrier layer 100 and a number of particles 102 are dispersed in the release layer 101. The diameters of at least a portion of the particles 102 have to be larger than the thickness of the release layer 101, so as to create roughness along the interface between the release layer 101 and a subsequently formed hardening layer 102, and so as to provide anti-fingerprint and selective degree of gloss (e.g., low gloss) on the surface of the final product. There is no specific requirement on the type of particles 102. The particles 102 could be wax, SiO₂, TiO₂, or polyurethane (PU) particles, or a combination of these particles, depending on the roughness or degree of gloss required. The diameters of the particles 102 are between 1 to 5 μm. Also, depending on the roughness or degree of gloss required, the amount or percentage of the particles 102 could be adjusted accordingly. Preferably, relative to the release layer 101, the weight percentage of the particles 102 is between 2 to 20% wt.

Subsequently, a hardening layer 103 is formed on the release layer 101, and an ink layer 104 on the hardening layer 103, and an adhesive layer 105 on the ink layer 104. The composite film 301 is thus formed.

Optionally, when the particles 102 are dispersed in the release layer 101, an additional polymer- or ion-type interface agent could be added as dispersion agent, so that the particles 102 are uniformly distributed. Preferably, the percentage of the polymer- or ion-type interface agent relative to the release layer 101 is between 0.1 to 2%.

After the composite film 301 is formed as described above, there should be an injection molding step to coat the composite film 301 on a work piece.

Depending on the combination of the particles 102, their diameters, and their weight percentages, different degrees of gloss at 60° angle could be achieved, as exemplified in the following table.

| | | | Degree of gloss |
|---|---|---|---|
| Particle Types | Diameter | wt % | at 60° angle |
| Grace Davison P403 | 3.7 μm | 7% | 13 |
| Grace Davison P403/ | 3.7 μm/2 μm | 11%/2% | 22 |
| Rohdia HP-34M | | | |
| Grace Davison C803/ | 3.7 μm/7 μm | 7%/5% | 9 |
| C805 | | | |
| Grace Davison C803/ | 3.7 μm/1.5 μm | 13%/3% | 0.2 |
| Nipsil F-100 | | | |

Therefore, the composite film according to the present invention is able to achieve a required degree of gloss or surface roughness by varying the combinations of particles and the particle diameters, so that the work piece (and the final product) enjoys superior anti-fingerprint capability. The product cost and process complexity is also reduced and the low yield problem from the non-uniform distribution of the particles is also resolved.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A composite film, comprising:
a carrier layer;
a release layer dispersed with a plurality of particles on said carrier layer;
a hardening layer on said release layer;
an ink layer on said hardening layer; and
an adhesive layer on said ink layer;
wherein at least a portion of said particles' diameters are larger than the thickness of said release layer.

2. The composite film according to claim 1, wherein said particles are wax, SiO₂, TiO₂, polyurethane (PU) particles, or a combination thereof.

3. The composite film according to claim 1, wherein the diameters of said particles are between 1 to 5 μm.

4. The composite film according to claim 1, wherein the weight percentage of said particles relative to said release layer is between 2 to 20% wt.

5. The composite film according to claim 1, wherein the degree of gloss at 60° angle of said composite film is between 2 to 99.

6. A method of manufacturing a composite film, comprising the steps of:
providing a carrier layer;
providing a release layer on said carrier layer;
dispersing a plurality of particles in said release layer;
providing a hardening layer on said release layer;
providing an ink layer on said hardening layer; and
providing an adhesive layer on said ink layer;
wherein at least a portion of said particles' diameters are larger than the thickness of said release layer.

7. The method of manufacturing a composite film according to claim 6, further comprising the following step:
conducting an injection molding step to apply said composite film on a work piece.

8. The method of manufacturing a composite film according to claim 6, wherein said particles are wax, SiO₂, TiO₂, polyurethane (PU) particles, or a combination thereof.

9. The method of manufacturing a composite film according to claim 6, wherein the diameters of said particles are between 1 to 5 μm.

10. The method of manufacturing a composite film according to claim 6, wherein the weight percentage of said particles relative to said release layer is between 2 to 20% wt.

11. The method of manufacturing a composite film according to claim 6, wherein the degree of gloss at 60° angle of said composite film is between 2 to 99.

12. The method of manufacturing a composite film according to claim 6, further comprising the step of:
adding a polymer- or ion-type interface agent so that said particles are uniformly distributed.

13. The method of manufacturing a composite film according to claim 12, wherein the percentage of said polymer- or ion-type interface agent relative to said release layer is between 0.1 to 2%.
